(19) United States
(12) Patent Application Publication
(10) Pub. No.: US 2025/0024990 A1
(43) Pub. Date: Jan. 23, 2025

(54) COMBINED POT STIRRING DEVICE AND STRAINER

(71) Applicant: TYLER RUBLE, Minneapolis, MN (US)

(72) Inventor: TYLER RUBLE, Minneapolis, MN (US)

(21) Appl. No.: 18/354,277

(22) Filed: Jul. 18, 2023

(51) Int. Cl. A47J 36/16; A47J 36/08; A47J 43/22

(52) U.S. Cl. CPC A47J 36/165; A47J 36/08; A47J 43/22

(57) ABSTRACT

A cooking vessel or insert used in a traditional cooking pot that includes a plurality of blades extending obliquely, partially along the inner surface of a largely cylindrical sidewall. Some versions of the apparatus include removeable blades made of a resilient or flexible material and some versions include structures that include two blades joined by a connecting piece such that each structure has two blade portions each of which insert into slits in the sidewall. Other versions of the device include a porous lid that extends partially across a top opening of the sidewall and that can include a shelf to prevent lateral movement of food on the lid.

### BACKGROUND OF THE INVENTION

### (a) Field of the Invention

The present invention is in the technical field of kitchen equipment. More particularly, the present invention is in the technical field of cooking utensils.

### (b) Background Art

There have been many attempts at creating an automated device to stir the contents of a pot while it is being used to prepare food. For example, Jeffrey LaVelle and his colleagues describe a motorized device that attaches to the outside of a cooking vessel and uses an electric motor to stir a device inserted into the pot in U.S. Pat. No. 5,617,774. Similarly, Zheng Peng describes a pot that has a motorized stirring device in U.S. Patent Publication Number 2008/0134905 A1. However, these devices are cumbersome, require the use of electricity and in some cases, specialized hardware.

Hideki Watanabe has developed a device described in U.S. Publication Number 2015/0041477 that does not require any moving parts or an electric motor. This device functions as an insert into a cooking vessel such as a pot. It lacks a bottom surface and has protrusions that extend away from the side walls of the insert. These protrusions are positioned and shaped to cause heated water to move around the protrusions causing movement in the water. As water at the bottom of the pot is heated, the warmer water rises and encounters angled fins or blades that are located on the side walls of the insert. The upward movement is redirected by the blades forcing the water to move laterally as it continues to rise to the surface of the water. This lateral movement of the water actually stirs the contents in the pot and obviates the need to manually stir the pot.

However, the separate insert tends to create some level of difficulty when it comes to removing the food from the cooking vessel, namely, the insert falls out when the user tries to dump the contents of the cooking vessel into a separate strainer and/or food sticks to the device when it is removed prior to the cooking vessel being emptied.

Previously, the inventor created a pot insert that contains the same or similar protrusions that cause water movement as water is boiled, but also combines the functionality of a strainer. Specifically, the inventor created a pot insert that contains the protrusions on the sides of the insert and also integrates a wire mesh material into the side walls as well as the bottom of the insert. Attempts to integrate a wire mesh material into the side walls and bottom of the pot insert itself presented an unexpected problem-when lifting the insert out of the pot, and thereby straining the contents of the pot, food tended to stick to the bottom and sides of the insert, i.e. the mesh material tends to cause foods such as pasta to stick to it leaving the user to manually pick the food out of the insert. In addition, when this type of insert was left in the pot and the pot was turned on its side to drain the water out of the pot, pasta tended to stick to the blades as well as the strainer portions of the insert.

As a result, the inventor determined that an improved structure would allow the user to use the same pot insert to drain pasta or other food cooked in the pot. Specifically, the inventor eliminated the bottom of the insert and instead of altering the side walls of the insert to incorporate a wire mesh material, the inventor has added a wire mesh material, i.e. a strainer, to the top of the insert. The strainer incompletely covers the top opening of the insert allowing the user to strain water out of the pot by turning the pot, containing the insert, onto its side. Food cannot get stuck on the bottom of the insert or the mesh sidewalls because they are no longer present.

Further, the partial strainer integrated into the top opening of the pot or pot insert can double as a steamer. While water is boiled in the pot with the insert inserted therein, food can be placed on the strainer allowing the user to steam food at the same time that they boil it.

These and other advantages of the present invention will be apparent to those of ordinary skill in the art from reading the following detailed description of the embodiments described and illustrated herein.

### BRIEF SUMMARY OF THE INVENTION

The present invention is an insert to be used with a cooking vessel and/or it is a cooking vessel. The device can be an insert that is meant to be used temporarily with a preexisting cooking vessel such as a pot or the structures disclosed herein can be integrated into an existing cooking vessel. Hereinafter, the device will be referred to as an insert for simplicity. The insert includes a sidewall that encloses a space and contains one or more, preferably a plurality, of blades, fins or protrusions (hereinafter “blades”) that are attached to or integrated into the sidewall. These blades are generally elongated, substantially flat, protrusions that extend away from the side walls of the insert or cooking vessel toward the center of the pot or insert, i.e. they protrude into the cooking space of the cooking vessel or insert. In this context, substantially flat means that the width and length of the blades are greater than the height or thickness of the blades. As discussed above, these blades redirect the motion of rising water as it is being heated in the pot causing lateral movement of the water in the pot. The insert has no bottom. If the device is integrated into a cooking vessel, then the cooking vessel will necessarily have a bottom.

In addition, the device includes a partial lid or cover for the insert that is attached to or integrated into the annular rim that surrounds the opening of the insert. The partial lid is recessed with respect to the annular lip that surrounds the opening at the top of the insert. This configuration allows the side walls of the insert that extend above the partial lid/strainer to hold food in place when it is placed on top of the partial lid.

### BRIEF DESCRIPTION OF THE SEVERAL VIEWS OF THE DRAWINGS

FIG. 1 is a top perspective view of a first embodiment of the present invention;

FIG. 2 is an exploded view of a second embodiment thereof;

FIG. 3A is a side perspective view thereof;

FIG. 3B is a cross sectional view of the blade in the second embodiment prior to insertion into the sidewall; and

FIG. 3C is a cross sectional view of the blade after insertion into the sidewall.

### DETAILED DESCRIPTION OF THE INVENTION

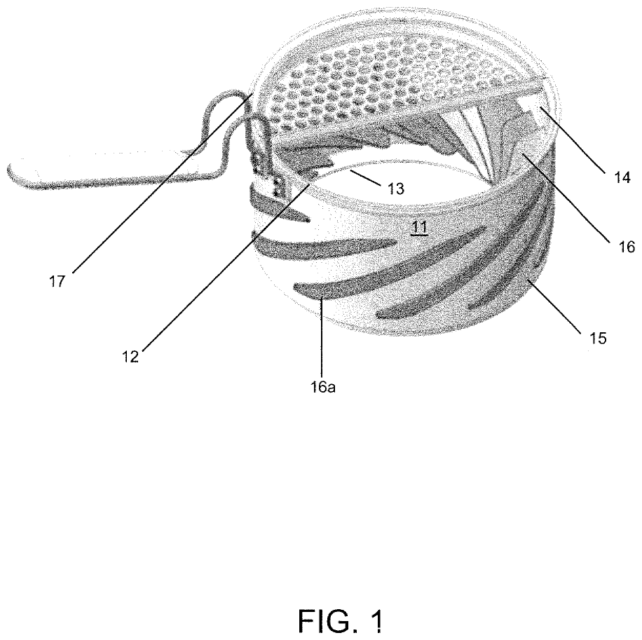

Referring now to the invention in more detail, in FIG. 1 there is shown a first embodiment of the cooking utensil or insert 10. The utensil 10 includes a sidewall 11 that in preferred embodiments is substantially cylindrical. Cylindrical in this disclosure means the sidewall has straight parallel sides and a circular or an oval cross-section and substantially cylindrical means the parallel sides are within 10 degrees of being parallel. The shape of the device is meant to mirror the shape of a typical cooking pot and in that sense can be varied as needed. The sidewall defines an opening at both ends, i.e. there is a top opening 12 and a bottom opening 13 of the sidewall 11. The sidewall 11 has an inner surface 14 and an outer surface 15. The inner surface 14 of the sidewall features one or more blades 16. Preferred embodiments of the device feature a plurality of blades 16 extending away from the inside of the sidewall 11 towards the center of the space enclosed by the sidewall 11. The blades 16 are elongated, substantially flat structures that extend obliquely along a portion of the inner surface 14 of the sidewall 11 which is to say that they are not parallel or perpendicular to a longitudinal axis of the device 10, but rather are slanted with respect to both the planes in which the openings at the top opening 12 and bottom opening 13 are situated and with respect to the longitudinal axis of the device.

FIG. 1 also shows the lid 17 of the device. As discussed above, when the inventor made the sidewall 11 of the device out of a mesh material, the food tended to stick to that mesh material when the user pulled the device 10 out of a pot (not shown) or tilted the pot with the device inserted therein to drain water out of both. The solution to this problem was to make a lid 17 that partially covers the top opening 12 of the sidewall 11 and to replace/eliminate the mesh material that made up earlier versions of the sidewall 11 including the bottom of the sidewall. In this embodiment, the sidewall 11 has a series of openings 16a adjacent to each blade 16. This is simply a result of the method of manufacturing as it is simpler to stamp the blades out of the sidewalls 11 of the device than it is to manufacture the device with blades integrated therein. This particular embodiment, like most cooking utensils, is made out of a metal or other similarly conducting, heat resistant material.

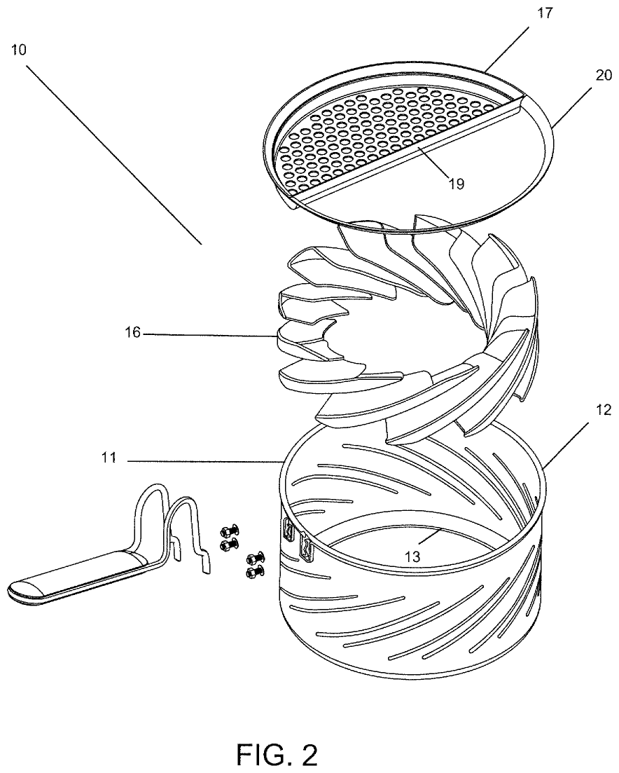

FIG. 2 shows an exploded view of a second embodiment. A cylindrical sidewall 11 encloses a space in which food and water can be placed for cooking. There is a top opening 12 and a bottom opening 13 at either end of the sidewall 11. This embodiment also includes a lid 17 that incompletely covers the top opening 12 of the device 10, i.e. the lid 17 partially traverses the top opening 12 of the device 10. Some embodiments of the lid 17 are made of a wire mesh material, but others simply feature a plurality of holes in the lid 17. In this particular embodiment, the lid 17 includes an annular flange 20 that attaches to the lid 17 and extends around the top opening 12 in the sidewall 11. The lid 17 in this embodiment covers approximately half of the top opening 12 of the device 10. In this context, substantially means within 10 percent of the stated value. In addition, in some embodiments, the lid 17 is also recessed with respect to the flange 20 that encircles the top opening 12 of the device 10 i.e., the lid 17 is sunken or not flush with the annular lip 20 around the top opening 12 of the sidewall 11. The sidewall 11 forms a barrier to food spillage. In addition, a side of the lid 17 terminates in a shelf 19 that prevents lateral movement of food on the lid 17 into the top opening 13 of the sidewall 11. The shelf 19 extends from one side of the sidewall 11 to the opposing side of the same sidewall 11. It is positioned such that it is substantially perpendicular to the surface of the mesh lid 17. This embodiment is meant to allow the user to steam food when the rest of the device 10 is in use. Typically, the device 10 is used with food cooking in liquid that is boiling and thus produces steam. The recessed mesh lid 17 allows the user to place food over the boiling water and hold it in place while the food in the device is being cooked, thereby allowing the food on the lid 17 to be steamed. The shelf 19 assists the user in keeping food being steamed in position. If the user tips the device 10 to one side, food placed on the mesh lid 17 will be held in place between the sidewall 11 that extends up past the mesh lid 17 on one side and the shelf 19 on the other side.

FIG. 2 also illustrates the plurality of blades that each embodiment includes. As was also shown in FIG. 1, there are a a plurality of blades 16 extending partially along the inner surface 14 of the sidewall 11 at an angle to the top and bottom openings 12, 13 of the device 10.

FIG. 2 also shows the position of the shelf 19 with respect to the lid 17. The lid 17 is porous so that it doubles as a strainer that can be used to strain water from the cooking vessel (not shown) into which this device 10 is inserted. As discussed previously, food can be placed on top of the porous lid so that the user can steam food at the same time that they are boiling water.

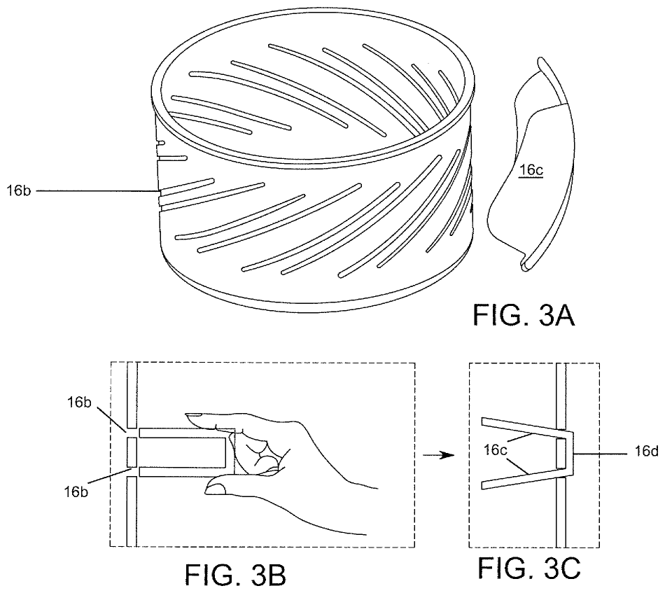

FIG. 1 shows an embodiment of the device in which the blades are made form the same material that forms the sidewall 11 of the device, i.e. the blades 16 are formed of portions of the sidewall 11 resulting in spaces 16a in the sidewall that are adjacent to the blades 16. FIGS. 2, 3A, 3B and 3C show an alternate embodiment of the same device. Specifically, the blades 16 are made as separate pieces or structures that are inserted into slits 16b in the sidewall 11 of the device. The slits 16b traverse the inner 14 and outer 15 surfaces of the sidewall 11 such that there is an opening in each portion of the sidewall 11 where each slit 16b is located. While each blade 16 could be individually inserted into the slits 16b featured by the sidewall 11, each blade 16 in this embodiment, is actually a double-sided structure that includes two blade portions 16c and a connecting portion 16d. Each blade portion 16c is an elongated strip of material like the blades in the first embodiment. The blades are mande of a resilient or flexible material. When no force is applied to the outside of the blade portions 16c, they tend to flare outwards such that the blade portions 16c are not parallel. During assembly, the user takes each blade 16, applies enough force to push the two blade portions 16c toward each other, then inserts each blade portion 16c into a different slots 16b located in the sidewall 11. When no more force is applied to the blade portions 16c, the blade portions 16c spring back into place such that they are no longer substantially parallel with each other, thereby holding tem in place in the sidewall 11 of the device 10.

The advantages of the present invention include, without limitation, the ability to cook or boil food in a pot without the need to constantly or periodically stirring the contents of the pot. Further, the user can empty the pot and strain the food without the need for a separate strainer and without the food getting caught on the inside of the cooking insert. These and other advantages of the present invention will be apparent to those of ordinary skill in the art from reading the following detailed description of the embodiments described and illustrated herein.

Reference throughout the specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout the specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

It is understood that the above-described embodiments are only illustrative of the application of the principles of the present invention. The present invention may be embodied in other specific forms without departing from its spirit or essential characteristics. The described embodiment, including the best mode, is to be considered in all respects only as illustrative and not restrictive. The scope of the invention is, therefore, indicated by the appended claims, if any, in conjunction with the foregoing description.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A cooking utensil comprising:
a substantially cylindrical sidewall that has a top opening at a top end and a bottom opening at a bottom end;
at least one elongated, substantially flat blade protruding from an inside surface of the sidewall and extending obliquely along a portion of the sidewall;
a lid that incompletely covers the top end of the annular sidewall.

2. The cooking utensil of claim 1 wherein the sidewall extends above the lid such that the lid is recessed.

3. The cooking utensil of claim 1 wherein the lid is made of a wire mesh material.

4. The cooking utensil of claim 2 wherein the lid has a plurality of holes in it.

5. A cooking utensil comprising:
a cylindrical sidewall with an annular opening at both the top and the bottom of the sidewall;
a plurality of elongated, substantially flat blades extending laterally away from the sidewall and extending obliquely along a portion of the sidewall;
a lid integrated into the annular opening at the top of the sidewall and extending across half of the opening at the top of the sidewall wherein said lid has a porous surface.

6. The cooking utensil of claim 4 wherein the lid is recessed with respect to the sidewall.

7. A cooking utensil comprising:
a cylindrical sidewall with an annular opening at the top of the sidewall and a second annular opening at the bottom of the sidewall;
a plurality of elongated slits traversing an inner surface of the sidewall and an outer surface of the sidewall;
a plurality of removeable blades wherein each of the plurality of blades is inserted into one of the plurality of slits in the sidewall such that each blade extends laterally away from the sidewall and obliquely along a portion of the inner surface of the sidewall.

8. The cooking utensil of claim 7 wherein each blade has two elongated blade portions and one connecting portion joining the two elongated blade portions and each of the blade portions of each blade is inserted into a different one of the plurality of slits in the sidewall.

9. The cooking utensil of claim 8 further comprising:
a lid integrated into the annular opening at the top of the sidewall and extending across half of the opening at the top of the sidewall.

10. The cooking utensil of claim 9 wherein said lid has a porous surface.
